(19) United States
(12) Patent Application Publication
(10) Pub. No.: US 2017/0129092 A1
(43) Pub. Date: May 11, 2017

(54) POWER TOOL

(71) Applicant: MAKITA CORPORATION, Anjo-shi (JP)

(72) Inventor: Kazuya KIMURA, Anjo-shi (JP)

(73) Assignee: MAKITA CORPORATION, Anjo-shi (JP)

(21) Appl. No.: 15/350,408

(22) Filed: Nov. 14, 2016

(30) Foreign Application Priority Data
Nov. 11, 2015 (JP) 2015-221658

(51) Int. Cl. B25F 5/00; B25B 21/00

(52) U.S. Cl. CPC B25F 5/001; B25B 21/00

(57) ABSTRACT

It is an object of the invention to provide a technique for rationally transmitting rotation of a motor to a tool accessory. According to the invention, a representative screwdriver 100 having a motor 110 and a driving mechanism 120 is provided. The driving mechanism 120 has a driving gear 125, a transmitting element 140 and a retainer 130. The transmitting element 140 consists of three or more rollers 140a. A tool bit 119 is held by a spindle 160 which is movable in a longitudinal direction. When the spindle 160 is located in a second position, the rollers 140a are held between the driving gear 125 and a spring receiver 150 so that the spindle 160 is rotationally driven.

### TECHNICAL FIELD

The present invention relates to a power tool that rotationally drives a tool accessory.

### BACKGROUND ART

Japanese laid-open patent publication No. 2012-135842 discloses a screwdriver that rotationally drives a driver bit. This screwdriver has a spindle to which the driver bit is mounted, a fixed hub that is rotatably disposed behind the spindle and has a tapered surface, a driving gear that is driven by a motor and has a tapered surface, six rollers disposed between the fixed hub and the driving gear, and a roller retaining member that retains the six rollers and is integrated with the spindle. The fixed hub, the driving gear and the roller retaining member are coaxially arranged with a rotation axis of the spindle, and the six rollers are arranged at equal intervals on a circumference around the rotation axis of the spindle via the roller retaining member.

### SUMMARY OF THE INVENTION

### Problem to be Solved by the Invention

In the above-described screwdriver, when a user presses the driver bit against a workpiece via a screw, the spindle and the driving gear move rearward. By this movement, the rollers are held between the tapered surface of the driving gear and the tapered surface of the fixed hub and exhibit a function as a wedge of connecting the driving gear and the hub. As the rollers revolve around the rotation axis of the spindle while rotating, the spindle and the driver bit are rotated via the roller retaining member. As a result, the user can perform a screw tightening operation on the workpiece.

Each component of the screwdriver has a tolerance (accumulated tolerance). Therefore, at the instant when the six rollers are held between the driving gear and the fixed hub, any one of the rollers may be first held therebetween. In this case, a reaction force which is caused when the first roller is held therebetween is propagated to a roller located in point symmetry to the first roller with respect to the rotation axis of the spindle. Therefore, the roller located in point symmetry to the first roller is held between the driving gear and the fixed hub. Thus, one pair of the rollers among the six rollers which are located in point symmetry are held between the driving gear and the fixed hub. At this time, the other four rollers may not be properly held between the driving gear and the fixed hub. As a result, wear of the pair of the rollers held between the driving gear and the fixed hub is accelerated. Therefore, in this point, further technical improvement is desired.

Accordingly, it is an object of the present invention to provide a technique for rationally transmitting rotation of a motor to a tool accessory in a power tool.

### DETAILED EXPLANATION OF THE INVENTION

The above-described problem is solved by the present invention. In the following description of parts and components relating to the present invention, descriptions relating to dimensions such as “equal intervals”, “the same shape” and “equilateral triangle” are matters relating to design dimensions of components or structures, and do not include manufacturing tolerance (accumulated tolerance).

According to a preferred aspect of the present invention, a power tool is provided which performs a prescribed operation by rotationally driving a tool accessory detachably held in a front end region of a tool body. The power tool includes a motor, a tool accessory holding part that is configured to be rotatable and to hold the tool accessory and a rotary drive mechanism that transmits rotation of the motor to the tool accessory holding part. The tool accessory holding part is configured to be switched by a user between a first position close to the front end region and a second position apart from the front end region in a rotation axis direction of the tool accessory holding part.

The rotary drive mechanism includes a driving member that is rotationally driven by the motor, a driven member that is arranged coaxially with the driving member and connected to the tool accessory holding part, a transmitting element and a transmitting member retaining element for retaining the transmitting element. The transmitting element is disposed between the driving member and the driven member and configured to be moved between a holding position to be held between the driving member and the driven member and a holding disabled position not to be held between the driving member and the driven member around a rotation axis of the driving member.

The transmitting element consists of a plurality of transmitting members that define at least a first transmitting member, a second transmitting member and a third transmitting member. The transmitting member retaining element consists of a plurality of transmitting member retaining parts that define at least a first transmitting member retaining part for retaining the first transmitting member, a second transmitting member retaining part for retaining the second transmitting member and a third transmitting member retaining part for retaining the third transmitting member. The transmitting member retaining element is disposed on a prescribed circumference around the rotation axis of the driving member. Further, a transmitting member non-retaining part is formed at a position point-symmetric to the first transmitting member retaining part on the circumference. The circumference defines one semi-circle and the other semi-circle by a diameter passing through the first transmitting member retaining part, and the second transmitting member retaining part is arranged on the one semi-circle and the third transmitting member retaining part is arranged on the other semi-circle.

In the power tool according to this aspect, when the tool accessory holding part is located in the first position, the transmitting members are placed in the holding disabled position, so that transmission of rotation of the driving member to the driven member is interrupted. Further, when the tool accessory holding part is switched to the second position by user's operation, the transmitting members are placed in the holding position, so that rotation of the driving member is transmitted to the driven member.

In order to stably connect the driving member and the driven member, it is preferable that at least three of the transmitting members are located in the holding position. In the power tool according to this aspect, at least three of the transmitting members can be stably placed in the holding position.

Specifically, in the process in which the transmitting members are switched from the holding disabled position to the holding position, all of the transmitting members may be simultaneously held between the driving member and the driven member, or one of the transmitting members may be first held before the others are held between the driving member and the driven member. In the latter case in which the first transmitting member is first held between the driving member and the driven member, a reaction force which is caused when the first transmitting member is held is propagated to a position point-symmetric to the first transmitting member with respect to the rotation axis of the driving member. In this position, however, the transmitting member non-retaining part is located. Therefore, the reaction force caused when the first transmitting member is placed in the holding position is dispersed and propagated to the other region on the prescribed circumference around the rotation axis of the driving member. The second and third transmitting members are placed in the holding position by receiving the dispersed reaction force.

In the power tool according to this invention, where at least three of the transmitting members can be stably placed in the holding position, rotation of the motor can be rationally transmitted to the tool accessory.

As a typical structure according to this invention, the power tool includes a screwdriver for screw tightening operation and an electric drill for drilling operation.

The tool body is configured as a housing which forms an outer shell of the power tool. Therefore, the tool body houses at least the motor, the tool accessory holding part and the rotary drive mechanism.

The driven member and the tool accessory holding part may be connected to each other directly, or indirectly via an intervening part such as a gear mechanism.

The transmitting element is moved between the holding position and the holding disabled position by relative movement of the transmitting members and the driven member around the rotation axis of the driving member. The transmitting member preferably includes a rolling member such as a roller and a ball. The rolling members forming the transmitting element preferably have the same diameter.

The tool accessory holding part can be switched from the first position to the second position by user's operation of pressing the tool accessory holding part against the workpiece via the tool accessory, while the tool accessory holding part can be switched from the second position to the first position by user's operation of separating the tool accessory holding part from the workpiece.

According to a further aspect of the power tool of the present invention, the transmitting member retaining parts may be arranged at equal intervals on the circumference around the rotation axis of the driving member.

In the power tool according to this aspect, the transmitting members are arranged at equal intervals on the circumference around the rotation axis of the driving member and held between the driving member and the driven member, so that rotation of the driving member can be stably transmitted to the driven member.

In order to arrange the transmitting member retaining parts at equal intervals on the circumference and form the transmitting member non-retaining part, an odd number of the transmitting member retaining parts can be provided.

According to a further aspect of the power tool of the present invention, the transmitting element may consist of totally nine transmitting members including the first, second and third transmitting members.

As described above, preferably, at least three of the transmitting members are located in the holding position. Further, preferably, lines connecting extending axes of the three transmitting members form an equilateral triangle.

In the power tool according to this aspect, where the transmitting element consists of nine transmitting members, three combinations of three transmitting members for forming the equilateral triangle can be made. Therefore, even if some of the transmitting members are not placed in the holding position due to accumulated tolerance, the other transmitting members can form the transmitting members which are placed in the holding position and have the relationship of the equilateral triangle. Thus, the driving member and the driven member can be stably connected to each other when the tool accessory holding part is located in the second position.

According to a further aspect of the power tool of the present invention, the rotary drive mechanism may have a retainer that is arranged coaxially with the driving member and connected to the tool accessory holding part. The retainer may have a cylindrical shape and have the transmitting member retaining element and a first engagement part extending inward of the transmitting member retaining element. The driven member may have a second engagement part that can engage with a region of the first engagement part located inward of the transmitting member retaining element. In such a structure, when the tool accessory holding part is located in the first position, the first engagement part and the second engagement part are disengaged from each other and the transmitting members are placed in the holding disabled position. When the tool accessory holding part is located in the second position, the first engagement part and the second engagement part are engaged with each other and thereby the transmitting members are placed in the holding position.

In the power tool according to this aspect, a region in which the first engagement part and the second engagement part are engaged with each other can be set inward of the transmitting member retaining element in the retainer. With this structure, the driven member can be reduced in size in the radial direction.

As a typical structure of the power tool according to this aspect, at least one of the first engagement part and the second engagement part may be formed by a lead surface. The first engagement part and the second engagement part may also be formed by a first lead surface and a second lead surface, respectively. The lead surface may be formed as a surface inclined in the rotation axis direction of the driving member, such as a spirally curved surface around the rotation axis of the driving member. This lead surface has a function of guiding relative movement of the retainer with respect to the driven member.

In this structure, the tool accessory holding part is moved from the first position to the second position by pressing the tool accessory against the workpiece. At this time, by engagement between the first engagement part and the second engagement part, the driven member is moved around the rotation axis of the driving member with respect to the retainer. With the structure in which at least one of the first engagement part and the second engagement part forms a lead surface, the driven member can be smoothly moved with respect to the retainer.

Specifically, when the user presses the tool accessory against the workpiece in order to perform a prescribed operation, the transmitting element is moved from the first position to the second position. As a result, rotation of the driving member is transmitted to the driven member and the tool accessory holding part is rotationally driven.

When the user stops pressing the tool accessory against the workpiece in order to finish the prescribed operation, the first engagement part and the second engagement part are disengaged from each other. Specifically, the driven member and the retainer are separated from each other, so that the transmitting members are moved from the holding position to the holding disabled position. Thus, transmission of rotation of the driving member to the driven member is interrupted.

According to a further aspect of the power tool of the present invention, the power tool may further include a rotation preventing part that prevents rotation of the tool accessory holding part by engaging with the tool accessory holding part when the tool accessory holding part is located in the first position. The tool accessory holding part is configured to be switched to an intermediate position between the first position and the second position in the rotation axis direction of the tool accessory holding part.

In this structure, when the tool accessory holding part is located in the first position, the tool accessory holding part and the rotation preventing part are engaged with each other, the driving member and the retainer are separated from each other, and the first engagement part and the second engagement part are disengaged from each other.

When the tool accessory holding part is located in the intermediate position, the tool accessory holding part and the rotation preventing part are disengaged from each other, the driving member and the retainer come in contact with each other so that the tool accessory holding part is rotationally driven, and the first engagement part and the second engagement part are disengaged from each other.

When the tool accessory holding part is located in the second position, the tool accessory holding part and the rotation preventing part are disengaged from each other, the driving member and the retainer come in contact with each other, and the first engagement part and the second engagement part are engaged with each other, so that the transmitting members are placed in the holding position and rotation of the driving member is transmitted to the driven member.

In the power tool according to this aspect, when the tool accessory holding part is located in the intermediate position, the driving member and the retainer are connected to each other by frictional force and the tool accessory holding part is rotated. When the tool accessory holding part is located in the second position, the driving member and the driven member are connected to each other by engagement between the first engagement part and the second engagement part and the tool accessory holding part is rotated. Specifically, the tool accessory holding part is rotated with smaller torque when located in the intermediate position, compared with when located in the second position.

As a typical structure of bringing the driving member and the retainer into contact with each other when the tool accessory holding part is located in the intermediate position or the second position, the driving member may be configured to have a bottomed cylindrical shape having a bottom and a wall, and a member arrangement region for the retainer may be formed by a space surrounded by the bottom and the wall. In this structure, the retainer is arranged in the member arrangement region such that a gap is formed between the driving member and the retainer when the tool accessory holding part is located in the first position. This gap defines the distance between the first position and the intermediate position. In the process that the tool accessory holding part is moved from the first position to the intermediate position, the length of this gap in the rotation axis direction of the driving member is shortened. When the tool accessory holding part is moved to the intermediate position, the driving member and the retainer come into contact with each other, so that the gap is eliminated.

Further, an opening through which the tool accessory holding part is inserted may be formed in the bottom of the driving member, and a bearing for supporting the tool accessory holding part may be provided in a member arrangement region for the driving member. In this structure, when the tool accessory holding part is located in the intermediate position, the driving member and the retainer can be brought into contact with each other via the outer ring of the bearing. Further, a ring-like spacer may be disposed between the bearing and the retainer. In this structure, when the tool accessory holding part is located in the intermediate position, the driving member and the retainer can be brought into contact with each other via the outer ring of the bearing and the spacer.

Further, rotation of the tool accessory holding part can be utilized as a function of the power tool when the tool accessory holding part is located in the intermediate position. For example, when the power tool is a screwdriver, the frictional force between the driving member and the retainer may be set to such a value that torque with which a screw tightening operation can be performed on a workpiece having a hardness lower than a prescribed hardness and cannot be performed on a workpiece having the prescribed hardness acts on the tool accessory holding part. The user may use the screwdriver to fix a gypsum board to a wooden backing with screws. A gypsum board has a lower hardness than a wooden backing. Therefore, even if the user tries to press the tool accessory holding part into a gypsum board via a screw, the pressing force may be absorbed by the gypsum board, so that a reaction force for moving the tool accessory holding part to the second position may not be obtained. In such a case, it can be designed such that the frictional force between the driving member and the retainer is set to “such a value that enough torque for performing a screw tightening operation on the gypsum board acts on the tool accessory holding part”.

When the frictional force between the driving member and the retainer is set to such a value and the tool accessory holding part is located in the intermediate position, the user can perform a screw tightening operation on the gypsum board. Further, when the screw reaches the wooden backing, the tool accessory holding part can obtain larger torque by moving to the second position. Thus, the screw tightening operation can be performed on the wooden backing with the screwdriver, so that the gypsum board can be fixed to the wooden backing.

According to a further aspect of the power tool of the present invention, the rotation preventing part and the tool accessory holding part may be engaged in surface contact with each other.

In the power tool according to this aspect, stability in engagement between the rotation preventing part and the tool accessory holding part can be enhanced, and wear caused by engagement and disengagement between the rotation preventing part and the tool accessory holding part can be suppressed.

According to a further aspect of the power tool of the present invention, the driving member may have a bottom wall, a side wall and a housing space surrounded by the bottom wall and the side wall. The bottom wall may have an opening through which the tool accessory holding part is inserted, and the housing space may house at least part of the rotary drive mechanism. In this structure, the side wall may have a spiral groove for holding grease which is supplied to the rotary drive mechanism.

In the power tool according to this aspect, grease held in the spiral groove of the driving member can be supplied to the rotary drive mechanism, so that operation of the rotary drive mechanism can be stabilized.

The spiral groove is preferably configured such that the turning direction of its spiral is the same as a direction of normal rotation of the tool accessory holding part. In this case, the direction of “normal rotation” of the tool accessory holding part refers to a direction in which the tool accessory holding part is more frequently rotated in the power tool. Specifically, when the power tool is a screwdriver, the direction of normal rotation refers to a rotation direction for screw tightening operation, and a direction of reverse rotation refers to a rotation direction for screw removing operation. In this structure, when the tool accessory holding part is rotated in the direction of normal rotation, grease exhibits a behavior of moving toward the bottom wall of the driving member, so that leakage of grease from the housing space can be prevented.

Further, the housing space of the driving member forms the above-described member arrangement region.

According to the present invention, a technique for rationally transmitting rotation of a motor to a tool accessory can be provided.

### BRIEF DESCRIPTION OF THE DRAWINGS

FIG. 1 is a sectional view showing the overall structure of a screwdriver according to the present invention.

FIG. 2 is a sectional partial view for showing a state in which a spindle is located in a first position.

FIG. 3 is a side view showing a driving mechanism when the spindle is located in the first position.

FIG. 4 is an exploded perspective view showing the driving mechanism.

FIG. 5 is a perspective view showing the driving gear.

FIG. 6 is a perspective view showing a bearing and a spacer.

FIG. 7 is a perspective view showing a retainer and a transmitting element.

FIG. 8 is a perspective view showing a lock sleeve, a spring receiver and a coil spring.

FIG. 9 is a sectional view for showing the state of the transmitting element when the spindle is located in the first position.

FIG. 10 is a perspective view of a front shaft part.

FIG. 11 is a perspective view of a rear shaft part.

FIG. 12 is a sectional view for showing the states of the front shaft part and a stopper when the spindle is located in the first position.

FIG. 13 is a sectional partial view for showing a state in which the spindle is located in an intermediate position.

FIG. 14 is a sectional view for showing the states of the front shaft part and the stopper when the spindle is located in the intermediate position.

FIG. 15 is a sectional partial view for showing a state in which the spindle is located in a second position.

FIG. 16 is a side view showing the driving mechanism when the spindle is located in the second position.

FIG. 17 is a sectional view for showing the state of the transmitting element when the spindle is located in the second position.

FIG. 18 is a sectional view for showing the states of the front shaft part and the stopper when the spindle is located in the second position.

### DETAILED EXPLANATION OF PREFERRED EMBODIMENTS OF THE INVENTION

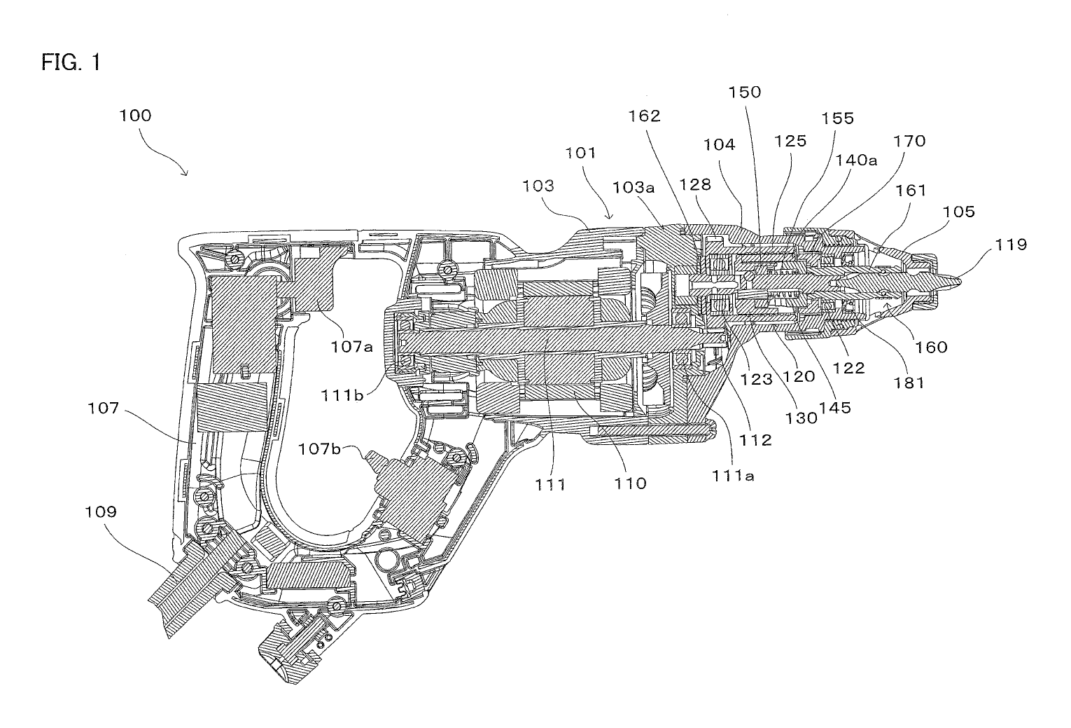

As a representative embodiment of a power tool according to the present invention, a screwdriver 100 is described with reference to FIGS. 1 to 18.

As shown in FIG. 1, the screwdriver 100 is configured to perform a screw tightening operation on a workpiece. The screwdriver 100 is an example embodiment that corresponds to the “power tool” according to the present invention.

The screwdriver 100 mainly includes a body 101 and a handle 107. A spindle 160 to which a tool bit 119 is detachably coupled is provided in a front end region of the body 101. The body 101, the tool bit 119 and the spindle 160 are example embodiments that correspond to the “tool body”, the “tool accessory” and the “tool accessory holding part”, respectively, according to the present invention.

The spindle 160 is configured to be rotatable and extends in a direction of its rotation axis. For the sake of convenience of explanation, in the rotation axis direction of the spindle 160 (the horizontal direction as viewed in FIG. 1), the spindle 160 side (the right as viewed in FIG. 1) is defined as the front of the screwdriver 100 and the handle 107 side (the left as viewed in FIG. 1) is defined as the rear of the screwdriver 100. Further, in the vertical direction of the screwdriver 100, the side of the spindle 160 is defined as the upper side and the side to which the handle 107 extends from the body 101 is defined as the lower side.

As shown in FIG. 1, the body 101 mainly includes a main housing 103, a front housing 104 and a locator 105. The main housing 103 mainly houses a motor 110. The front housing 104 is mounted to the front of the main housing 103 and houses a driving mechanism 120 which rotationally drives the spindle 160. The motor 110 and the driving mechanism 120 are example embodiments that correspond to the “motor” and the “rotary drive mechanism”, respectively, according to the present invention.

As shown in FIG. 1, a partition wall 103a for demarcating the inside of the main housing 103 from the inside of the front housing 104 is formed on the front end of the main housing 103 and extends in the vertical direction. An output shaft 111 of the motor 110 is rotatably supported by a bearing 111a held by the partition wall 103a and a bearing 111b held by a rear portion of the main housing 103. The motor 110 is arranged in the body 101 such that the rotation axis direction of the output shaft 111 is parallel to the rotation axis direction of the spindle 160.

The locator 105 is mounted to cover the front housing 104 in a front end region of the front housing 104. The tool bit 119 is detachably coupled to the spindle 160 such that a tip of the tool bit 119 protrudes from the locator 105. The locator 105 can move in the rotation axis direction of the spindle 160 with respect to the front housing 104 and fixed in a prescribed position selected in the rotation axis direction. Specifically, by selecting the position of the locator 105 with respect to the spindle 160, the amount of protrusion of the tool bit 119 from the locator 105 can be adjusted. In this manner, the screwing depth can be set.

As shown in FIG. 1, the handle 107 is connected to the rear of the main housing 103. The handle 107 has a trigger 107a and a changeover switch 107b. When the trigger 107a is operated, electric current is supplied from outside via a power cable 109 and the motor 110 is driven. Further, the direction of rotation of the output shaft 111 of the motor 110 is switched by operating the changeover switch 107b. Specifically, the output shaft 111 is driven in a selected direction of either one of normal rotation and reverse rotation.

### (Driving Mechanism)

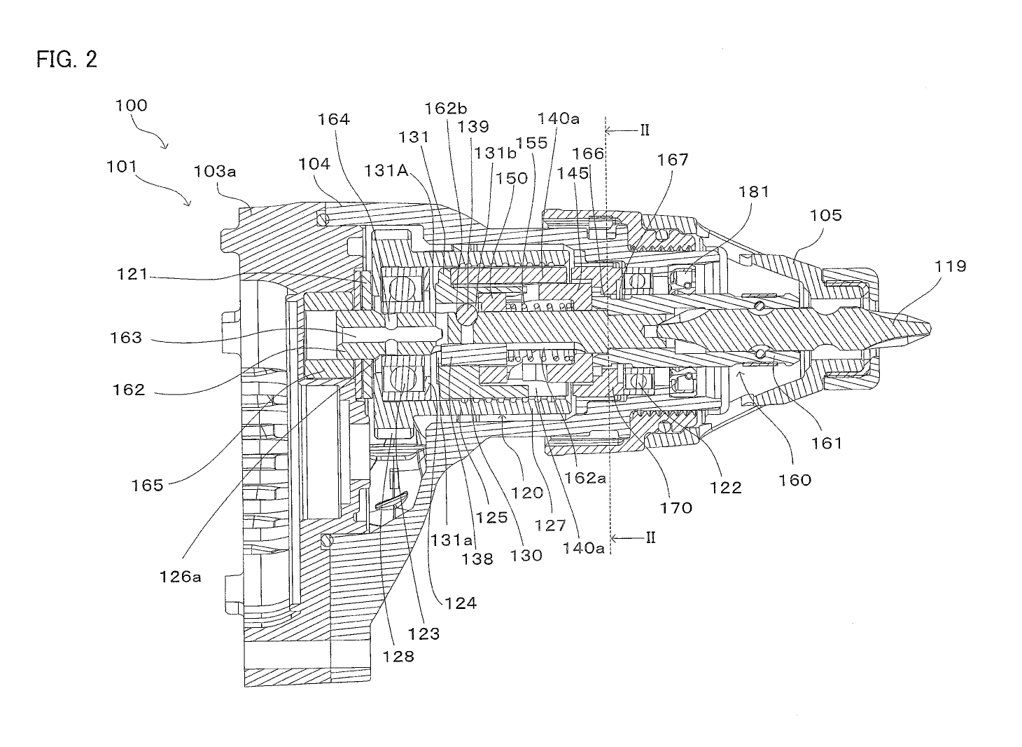

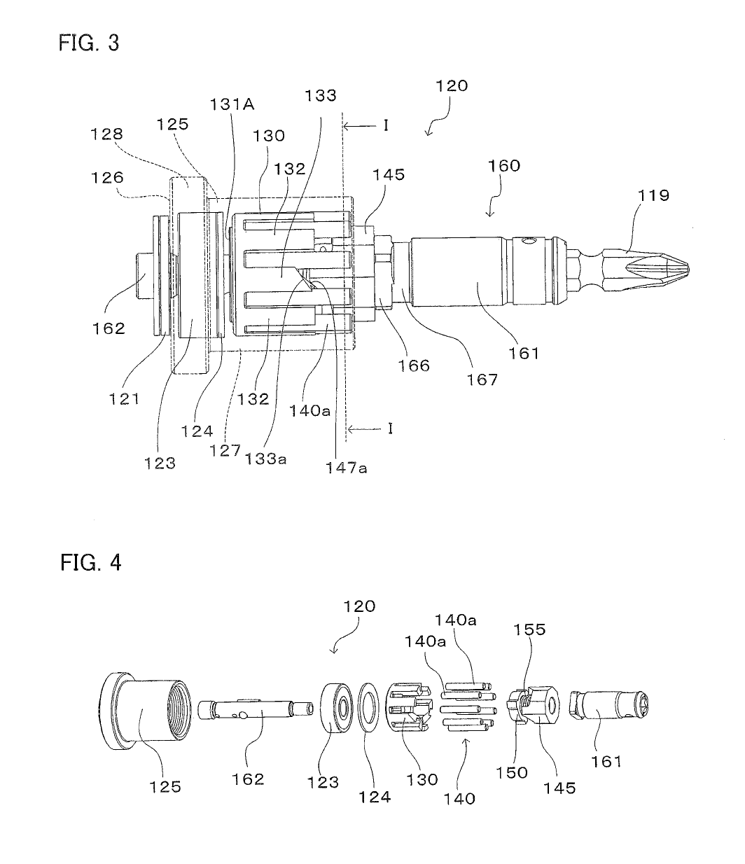

The structure of the driving mechanism 120 is now described with reference to FIGS. 2 to 11. As shown in FIGS. 2 to 4, the driving mechanism 120 mainly includes a driving gear 125, a retainer 130, rollers 140a, a lock sleeve 145, a spring receiver 150 and a coil spring 155. FIG. 2 is a sectional view showing an essential part of the driving mechanism 120, but the motor 110 and the output shaft 111 are not shown for convenience sake. FIG. 3 is a side view of the driving mechanism 120, but the driving gear 125 is shown by a broken line. FIG. 4 is an exploded perspective view showing components of the driving mechanism 120. The driving gear 125, the retainer 130, the roller 140a and the lock sleeve 145 are example embodiments that correspond to the “driving member”, the “retainer”, the “transmitting member” and the “driven member”, respectively, according to the present invention.

As shown in FIG. 2, the driving gear 125, the retainer 130, the lock sleeve 145, the spring receiver 150 and the coil spring 155 are arranged coaxially with the rotation axis of the spindle 160. Thus, the retainer 130, the lock sleeve 145, the spring receiver 150 and the coil spring 155 are arranged coaxially with the rotation axis of the driving gear 125.

### (Driving Gear)

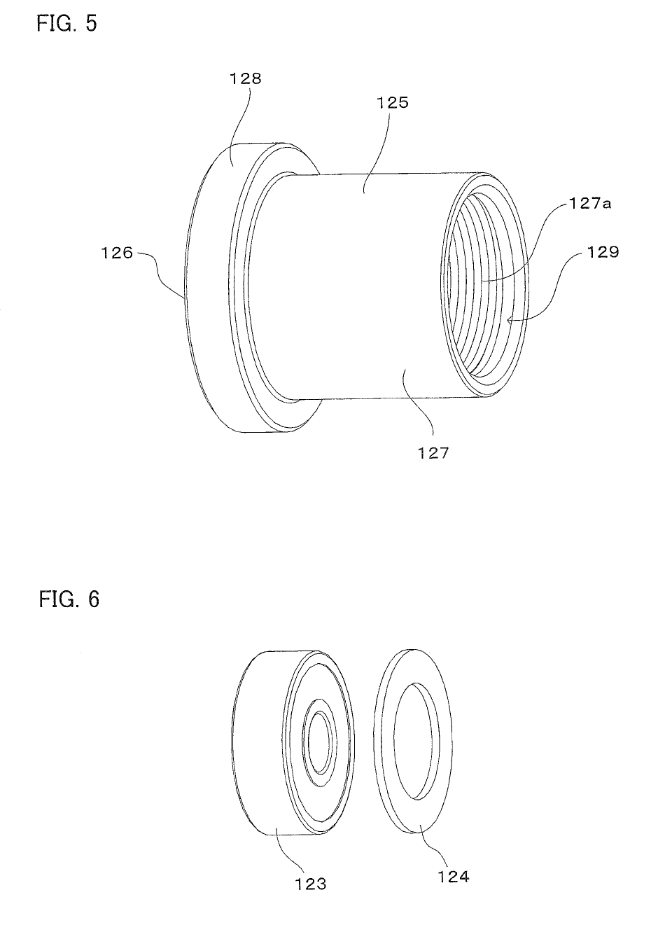

As shown in FIG. 5, the driving gear 125 has a generally cup-like shape open to the front and having a bottom wall 126 and a side wall 127. The bottom wall 126 and the side wall 127 are example embodiments that correspond to the “bottom wall” and the “side wall”, respectively, according to the present invention.

As shown in FIG. 2, gear teeth 128 are provided on the outer periphery of the side wall 127 of the driving gear 125 and engage with gear teeth 112 (see FIG. 1) formed in the output shaft 111 of the motor 110. The driving gear 125 is rotatably supported with respect to the body 101 (the partition wall 103a) by a needle bearing 121 provided on the rear of the bottom wall 126.

As shown in FIG. 2, a through hole 126a is formed through the center of the bottom wall 126, and a rear shaft part 162 of the spindle 160 is inserted through the through hole 126a. The through hole 126a is an example embodiment that corresponds to the “opening” according to the present invention. As shown in FIGS. 2 and 5, a housing space 129 is formed inside of the side wall 127. The housing space 129 houses a bearing 123, the retainer 130, the rollers 140a, the lock sleeve 145 and the coil spring 155. The housing space 129 is an example embodiment that corresponds to the “housing space” according to the present invention.

Further, as shown in FIG. 5, a spiral groove 127a is formed in the inside of the side wall 127 to hold grease. With this structure, grease held in the spiral groove 127a is supplied to the parts housed in the housing space 129. Therefore, the driving mechanism 120 is stably driven via the grease. The spiral groove 127a is configured such that the turning direction of its spiral is the same as a screw tightening direction (normal direction). Thus, the grease can be drawn toward the bottom wall 126 during screw tightening opeartion. Further, the screwdriver 100 is also capable of rotating a screw in a screw removing direction (reverse direction) in order to remove the screw from the workpiece. In usage of the screwdriver 100, a screw tightening operation of rotating a screw in the normal direction is assumed to be more frequently performed than a screw removing operation of rotating a screw in the reverse direction. Therefore, by providing such that the turning direction of the spiral of the spiral groove 127a is the same as the normal direction of screw rotation, the grease can be efficiently held in the driving gear 125. The spiral groove 127a is an example embodiment that corresponds to the “spiral groove” according to this invention.

As shown in FIG. 2, the bearing 123 rotatably supports the spindle 160. As shown in FIGS. 2 and 6, a spacer 124 is arranged in contact with an outer ring of the bearing 123. Thus, the spacer 124 can rotate together with the driving gear 125 via the outer ring of the bearing 123.

### (Retainer)

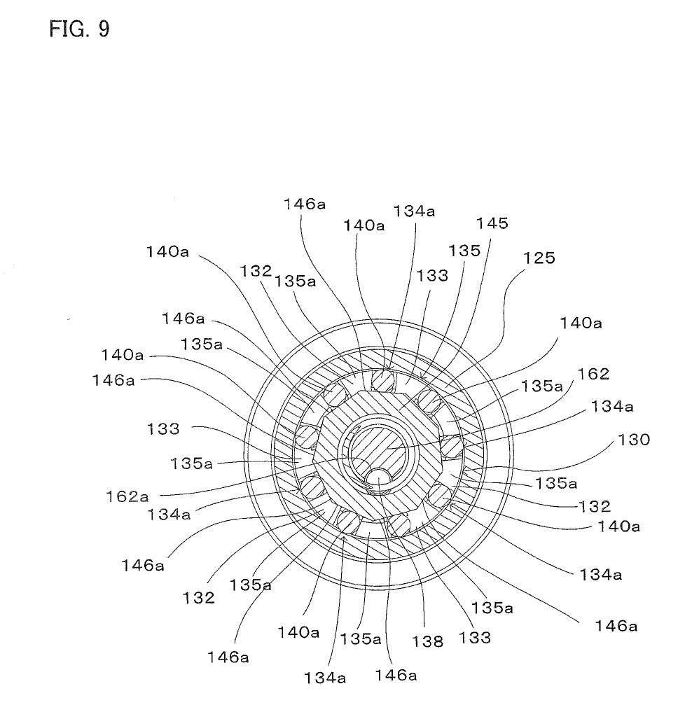

As shown in FIGS. 2 to 4, 7 and 9, the retainer 130 is a cylindrical member and is arranged coaxially with the driving gear 125. FIG. 9 is a sectional view taken along line I-I in FIG. 3.

As shown in FIG. 3, the retainer 130 has a base 131 facing the bottom wall 126 of the driving gear 125, and a first side wall 132 and a second side wall 133 facing the side wall 127 of the driving gear 125. The base 131 has a contact part 131A protruding rearward from a rear surface of the retainer 130. The contact part 131A is configured to come in contact with the spacer 124 mounted on the outer ring of the bearing 123.

As shown in FIG. 2, the base 131 has a through hole through which the rear shaft part 162 of the spindle 160 is inserted. The through hole of the base 131 has a first engagement hole 131a which holds a cylindrical engagement pin 138, and a second engagement hole 131b which holds an engagement ball 139 so as to be movable together with the spindle 160 in the rotation axis direction of the spindle 160.

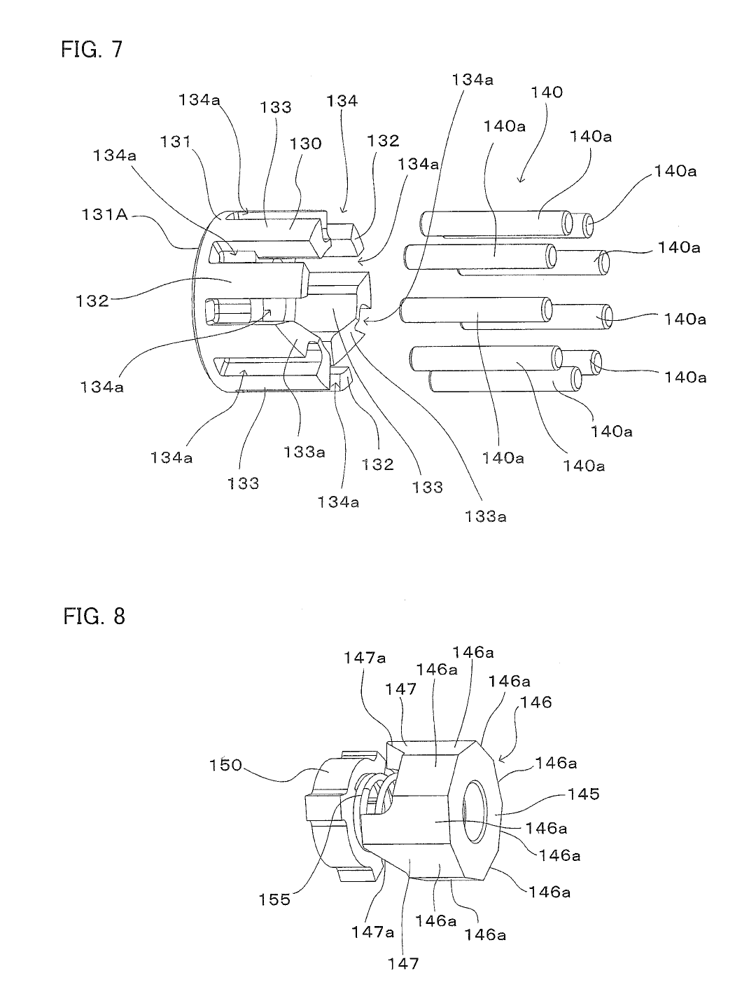

As shown in FIGS. 3 and 7, the first and second side walls 132, 133 extend forward from the base 131 in the axial direction of the retainer 130 (the rotation axis direction of the spindle 160).

As shown in FIG. 7, three first side walls 132 and three second side walls 133 are arranged alternately on a circumference around a center axis of the retainer 130. A prescribed space is formed between the first and second side walls 132, 133 in the circumferential direction of the retainer 130. Further, a prescribed space is formed by partially cutting out an outer side of the second side wall 133. The prescribed space between the first and second side walls 132, 133 and the prescribed space on the outer side of the second side wall 133 form a roller retaining element 134 for retaining a transmitting element 140. The transmitting element 140 consists of nine rollers 140a. Thus, the roller retaining element 134 consists of nine roller retaining parts 134a. The roller retaining element 134, the transmitting element 140 and the roller retaining part 134a are example embodiments that correspond to the “transmitting member retaining element”, the “transmitting element” and the “transmitting member retaining part”, respectively, according to the present invention.

Further, a region of the first side wall 132 or second side wall 133 located in point symmetry to the roller retaining element 134 with respect to the rotation axis of the spindle forms a roller non-retaining element 135. In this embodiment, the roller non-retaining element 135 consists of nine roller non-retaining parts 135a. Specifically, regions of the first side wall 132 or second side wall 133 located in point symmetry to the roller retaining parts 134a with respect to the rotation axis of the spindle 160 form the roller non-retaining parts 135a. The roller non-retaining part 135a is an example embodiment that corresponds to the “transmitting member non-retaining part” according to the present invention.

As shown in FIGS. 7 and 9, each of the rollers 140a is a cylindrical member and all the nine rollers 140a are configured to have the same diameter. The nine roller retaining parts 134a are arranged at equal intervals on a circumference around the rotation axis of the spindle 160. Therefore, when the rollers 140a are disposed in the roller retaining parts 134a, a line connecting center axes of the adjacent rollers 140a can form a regular nonagon. Further, the features that “the nine rollers 140a have the same diameter”, “the nine roller retaining parts 134a are arranged at equal intervals”, and “a line connecting center axes of the adjacent rollers 140a forms a regular nonagon” are matters relating to design dimensions, and do not include manufacturing tolerance (accumulated tolerance).

As shown in FIGS. 3 and 7, the second side wall 133 has an inclined part 133a in the form of an inclined surface formed on its front end and inclined with respect to the rotation axis of the spindle 160 (the center axis of the retainer 130). The inclined parts 133a of the three second side walls 133 are arranged at equal intervals on a circumference around the center axis of the retainer 130. The three inclined parts 133a are configured as a lead surface extending along the circumferential direction of the retainer 130. The three inclined parts 133a are configured to be inclined at the same angle with respect to a contour line (outer periphery) of the retainer 130 in a cross section orthogonal to the axial direction of the retainer 130. Specifically, the three inclined parts 133a are configured in a triple helical shape. Further, compared with the first side walls 132, the inclined parts 133a extend to protrude in an inward direction of the retainer 130. The inclined part 133a is an example embodiment that corresponds to the “first engagement part” according to the present invention.

### (Lock Sleeve)

As shown in FIGS. 2 to 4, 8 and 9, the lock sleeve 145 has a generally regular nonagonal shape having a hollow part inside.

As shown in FIG. 2, the lock sleeve 145 is disposed coaxially with the driving gear 125 and the retainer 130 in front of the retainer 130. The lock sleeve 145 is arranged such that its front end can come into contact with a rear end of a front shaft part 161 of the spindle 160.

As shown in FIGS. 8 and 9, the lock sleeve 145 has nine roller engagement parts 146a corresponding to the nine sides of the nonagonal lock sleeve 145 which can engage with the rollers 140a. The nine roller engagement parts 146a form a roller engagement element 146 which can engage with the transmitting element 140.

Further, as shown in FIG. 8, a retainer engagement part 147 is formed in a rear end region of each of three of the nine roller engagement parts 146a and can come in and out of contact with the second side wall 133 of the retainer 130 in the rotation axis direction of the spindle 160. In the nine roller engagement parts 146a, the three retainer engagement parts 147 are arranged at equal intervals.

As shown in FIG. 8, each of the retainer engagement parts 147 has an inclined part 147a in the form of an inclined surface formed on its rear end and inclined with respect to the rotation axis of the spindle 160. The inclined part 147a is formed to correspond to each of the three inclined parts 133a of the second side walls 133. Specifically, the inclined part 147a can engage (contact) with the inclined part 133a. As described above, the inclined part 133a of the retainer 130 extends to protrude inward of the first side walls 132. The inclined part 147a is configured to engage with a region of the inclined part 133a located inward of the first side walls 132. With this structure, the lock sleeve 145 can be reduced in size in the radial direction.

The three inclined parts 147a are configured as a lead surface extending along the circumferential direction around the axis of the lock sleeve 145. The three inclined parts 147a are configured to be inclined at the same angle with respect to a contour line (outer periphery) of the retainer engagement part 147 in a cross section orthogonal to the axial direction of the lock sleeve 145. Specifically, the three inclined parts 147a are configured in a triple helical shape. The inclined part 147a is an example embodiment that corresponds to the “second engagement part” according to the present invention.

### (Spring Receiver)

As shown in FIGS. 2 to 4 and 8, the spring receiver 150 is disposed inside the retainer 130. The spring receiver 150 is disposed between the base 131 of the retainer 130 and the lock sleeve 145 in the longitudinal direction of the screwdriver 100. The spring receiver 150 has a through hole through which the spindle 160 is inserted. The through hole has an engagement region which is engaged with the engagement pin 138 disposed in a groove 162a of the rear shaft part 162 of the spindle 160. Thus, the spring receiver 150 is connected to the spindle 160 so as to always rotate together with the spindle 160.

### (Coil Spring)

As shown in FIGS. 2 to 4 and 8, the coil spring 155 is arranged coaxially with the spindle 160 such that the spindle 160 is inserted therethrough. A front region of the coil spring 155 is disposed within the hollow part of the lock sleeve 145 and the front end of the coil spring 155 is held in contact with the lock sleeve 145. Further, the rear end of the coil spring 155 is held in contact with the front surface of the spring receiver 150. Thus, the coil spring 155 biases the lock sleeve 145 and the spindle 160 forward. Further, the coil spring 155 biases the spring receiver 150 and the retainer 130 rearward.

### (Spindle)

The structure of the spindle 160 is now described with reference to FIGS. 2 to 4 and 10 to 12. FIG. 2 is a sectional view taken along line II-II in FIG. 2.

As shown in FIG. 2, the spindle 160 is a generally cylindrical, elongate member made of metal and is provided to be movable in the longitudinal direction of the screwdriver 100 (the rotation axis direction of the spindle 160). As shown in FIG. 2, the spindle 160 mainly consists of the front shaft part 161 and the rear shaft part 162 integrally connected to the front shaft part 161. The tool bit 119 is detachably coupled to the front shaft part 161. A ball and a leaf spring are provided in the front shaft part 161. The ball is biased by the leaf spring and engages with the tool bit 119, so that the tool bit 119 is held by the front shaft part 161. The front shaft part 161 is rotatably supported by a front bearing 122 held by the front housing 104. Further, an oil seal 181 is disposed between the front housing 104 and the front shaft part 161 in front of the front bearing 122 which supports the front shaft part 161.

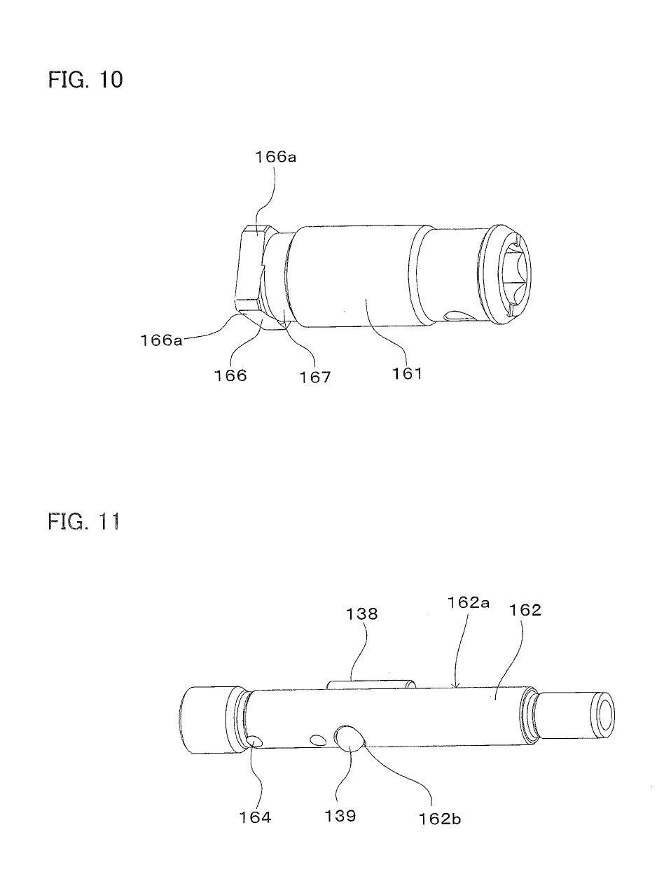

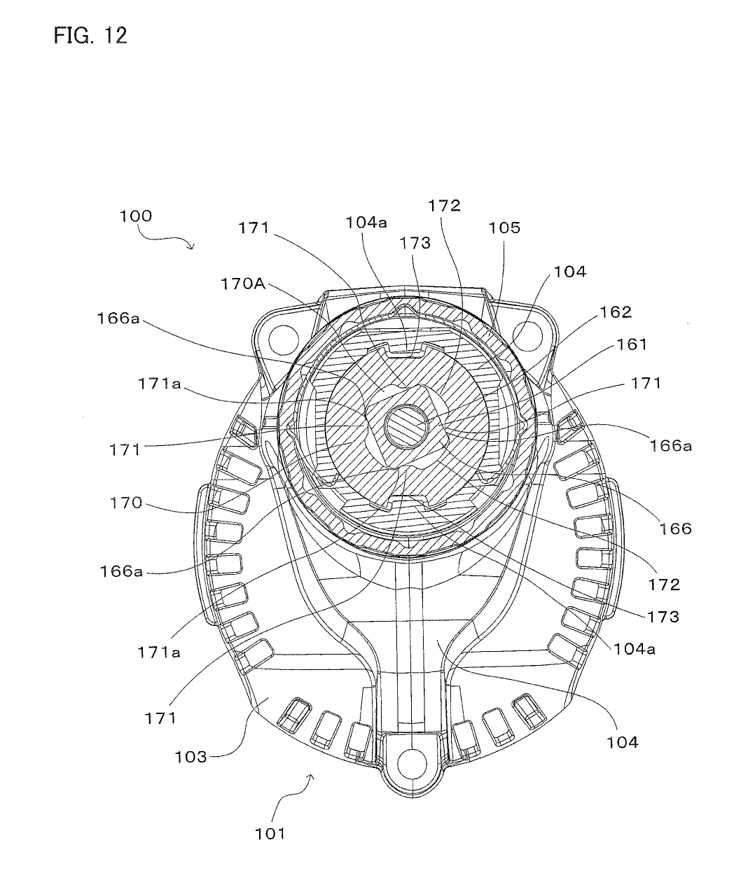

As shown in FIGS. 10 and 12, an engagement part 166 is formed in a rear end region of the front shaft part 161 and can engage with a stopper 170. The engagement part 166 has an engagement surface 166a. Further, a non-engagement part 167 which cannot engage with the stopper 170 is formed on the front side of the engagement part 166. The non-engagement part 167 has a cylindrical shape having a circular section.

As shown in FIG. 12, the engagement part 166 has a macroscopically square section in the vertical direction. The distance between opposed sides of the square section of the engagement part 166 is set to be substantially equal to the diameter of the circular section of the non-engagement part 167. Thus, the length of a diagonal of the square section of the engagement part 166 is longer than the diameter of the circular section of the non-engagement part 167.

As shown in FIG. 2, the rear shaft part 162 is configured to be coaxially connected to the front shaft part 161. The rear end of the rear shaft part 162 is supported so as to be rotatable and slidable in the longitudinal direction with respect to a ring-like rear end bearing 165 provided in the partition wall 103a of the main housing 103. The rear end bearing 165 is configured as an oilless bearing. Thus, the spindle 160 is supported by the front bearing 122 and the rear end bearing 165.

As shown in FIG. 2, the rear shaft part 162 is inserted through the driving gear 125, the retainer 130 and the lock sleeve 145, and the rear end of the rear shaft part 162 protrudes rearward from the driving gear 125. The spindle 160 is prevented from moving forward in the axial direction by contact of the rear end of the groove 162a with the engagement pin 138. Further, the engagement pin 138 is prevented from moving forward by contact with the rear end of the coil spring 155.

As shown in FIG. 2, the rear shaft part 162 has a hollow part 163 open to a rear end surface of the rear shaft part 162 and extending inside the spindle 160 in the axial direction. Thus, the hollow part 163 communicates with the inside of the rear end bearing 165. Further, as shown in FIGS. 2 and 11, the rear shaft part 162 has a communication hole 164 formed through the rear shaft part 162 in the radial direction so as to provide communication between the hollow part 163 and the inside of the front housing 104. Thus, the inside of the front housing 104 and the inside of the rear end bearing 165 communicate with each other via the hollow part 163. With such a structure, when the spindle 160 moves rearward, compression of air inside the rear end bearing 165 is prevented. In other words, by providing the communication hole 164, air inside the rear end bearing 165 is not compressed, so that rearward movement of the spindle 160 is not hindered.

### (Stopper)

As shown in FIGS. 1, 2 and 12, the stopper 170 is a generally cylindrical member. As shown in FIG. 12, a through hole 170A is formed in the inside of the stopper 170 and the front shaft part 161 of the spindle 160 is inserted therethrough. The through hole 170A has four protruding regions 171, engagement surfaces 171a extending on the both sides of the protruding regions 171 and curved surface regions 172 connecting adjacent ones of the engagement surfaces 171a. Opposed ones of the four protruding regions 171 are formed parallel to each other. The protruding regions 171, the engagement surfaces 171a and the curved surface regions 172 extend in the rotation axis direction of the spindle 160.

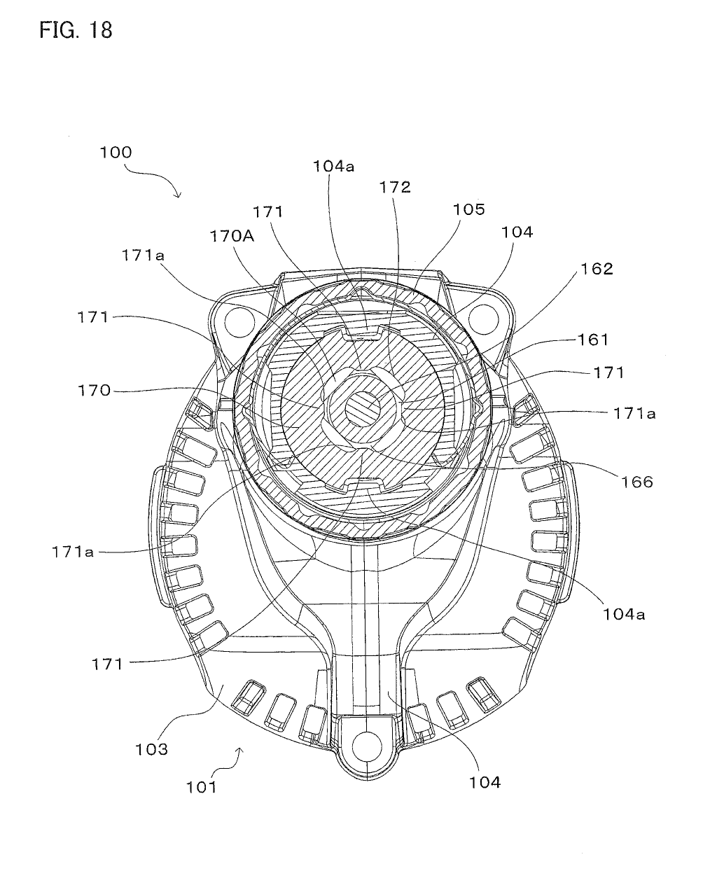

As shown in FIG. 12, the curved surface regions 172 of the through hole 170A are formed in a circular arc shape which is part of a circle having a diameter longer than the length of the diagonal of the square section of the engagement part 166. Therefore, when the engagement part 166 of the spindle 160 is located in the through hole 170A of the stopper 170 and the spindle 160 is rotated from a position shown in FIG. 18 to a position shown in FIG. 12, the engagement surfaces 166a of the spindle 160 engage (contact) with the engagement surfaces 171a of the stopper 170, so that rotation of the spindle 160 is prevented. Specifically, the spindle 160 and the stopper 170 are engaged in surface contact with each other. With this structure, wear caused by engagement and disengagement between the spindle 160 and the stopper 170 can be suppressed.

Further, the engagement part 166 of the spindle 160 does not engage (contact) with the curved surface regions 172 of the stopper 170. The non-engagement part 167 of the spindle 160 does not engage with the engagement surfaces 171a of the stopper 170. Therefore, when the spindle 160 is moved rearward and the non-engagement part 167 is located in the through hole 170A of the stopper 170, the spindle 160 is allowed to rotate in either direction without being hindered.

As shown in FIG. 12, a recess 173 is formed in the outer periphery of the stopper 170. When the recess 173 is engaged with a projection 104a formed on the front housing 104, the stopper 170 is prevented from rotating around the rotation axis of the spindle 160. Thus, the stopper 170 is mounted to the front housing 104 while being prevented from rotating.

### (Basic Operation of Screwdriver)

In the screwdriver 100 having the above-described structure, the motor 110 is driven when the trigger 107a is operated. The driving gear 125 is rotationally driven by rotation of the output shaft 111 of the motor 110. When the rotation of the driving gear 125 is transmitted to the spindle 160, the tool bit 119 held by the spindle 160 is rotated and performs a prescribed operation (screw tightening operation or screw removing operation). Specifically, a screw tightening operation is performed when the tool bit 119 (the spindle 160) is rotationally driven in a prescribed direction (hereinafter referred to as normal direction), while a screw removing operation is performed when the tool bit 119 (the spindle 160) is rotationally driven in a direction opposite to the prescribed direction (hereinafter referred to as reverse direction). The direction of rotational driving of the spindle 160 is switched according to the position of the spindle 160 in the longitudinal direction of the screwdriver 100.

Operation of the screwdriver 100 is now described in more detail. For the convenience sake, operation of the screwdriver 100 in a screw tightening operation in which the spindle 160 is rotated in the normal direction is mainly explained.

### (When the Spindle is Located in a First Position)

FIGS. 1 to 3, 9 and 12 show the state in which the spindle 160 is located in a front position in the longitudinal direction of the screwdriver 100. This state is an unloaded state in which a screw (not shown) on the tip of the tool bit 119 is not pressed against the workpiece by the user. The position of the spindle 160 in this unloaded state is referred to as a first position. This first position is an example embodiment that corresponds to the “first position” according to this invention.

As shown in FIG. 3, when the spindle 160 is located in the first position, the inclined part 147a of the retainer engagement part 147 of the lock sleeve 145 does not come in contact with the inclined part 133a of the retainer 130. In this state, as shown in FIG. 9, each roller 140a is held in a substantially middle region of the roller engagement part 146a of the lock sleeve 145 in the circumferential direction of the spindle 160. It is configured such that the roller 140a is not held between the lock sleeve 145 and the side wall 127 of the driving gear 125 in the substantially middle region of the roller engagement part 146a. The substantially middle region of the roller engagement part 146a is also referred to as a roller non-holding position or a rotation transmitting disabled position in the roller engagement part 146a. This rotation transmitting disabled position is an example embodiment that corresponds to the “holding disabled position” according to this invention.

As described above, each roller 140a is held in the roller non-holding position in the roller engagement part 146a. Therefore, when the spindle 160 is located in the first position, rotation of the driving gear 125 is not transmitted to the spindle 160 via the roller 140a even if the user operates the trigger 107a.

Further, when the spindle 160 is located in the first position, as shown in FIG. 2, the engagement pin 138 is engaged with the retainer 130 and the spindle 160, so that the retainer 130 and the spindle 160 are integrated. Further, the spindle 160 and the spring receiver 150 are integrated via the engagement pin 138.

As shown in FIG. 2, when the spindle 160 is located in the first position, the contact part 131A of the retainer 130 is spaced from the spacer 124. Therefore, rotation of the driving gear 125 is not transmitted to the retainer 130 via the bearing 123 and the spacer 124.

Further, as shown in FIG. 12, rotation of the spindle 160 is prevented by surface contact between the engagement surfaces 166a of the spindle 160 and the engagement surfaces 171a of the stopper 170. Thus, when the spindle 160 is located in the first position, the spindle 160 is prevented from rotationally driving in the normal direction, so that a screw tightening operation is not performed.

### (When the Spindle is Located in an Intermediate Position)

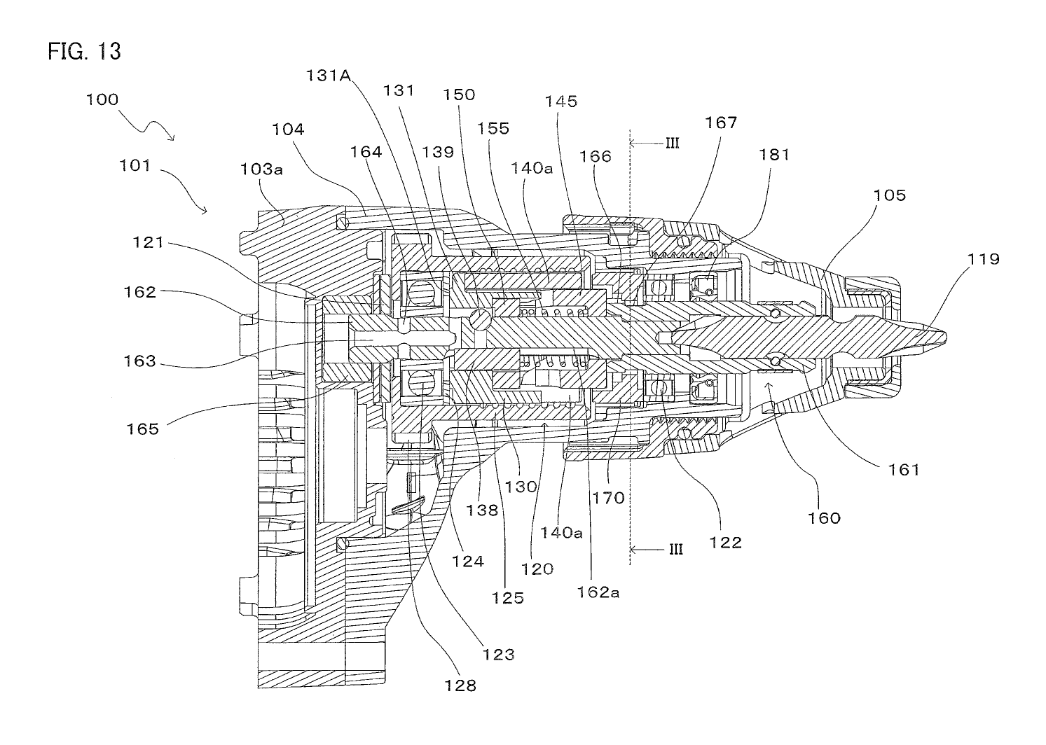

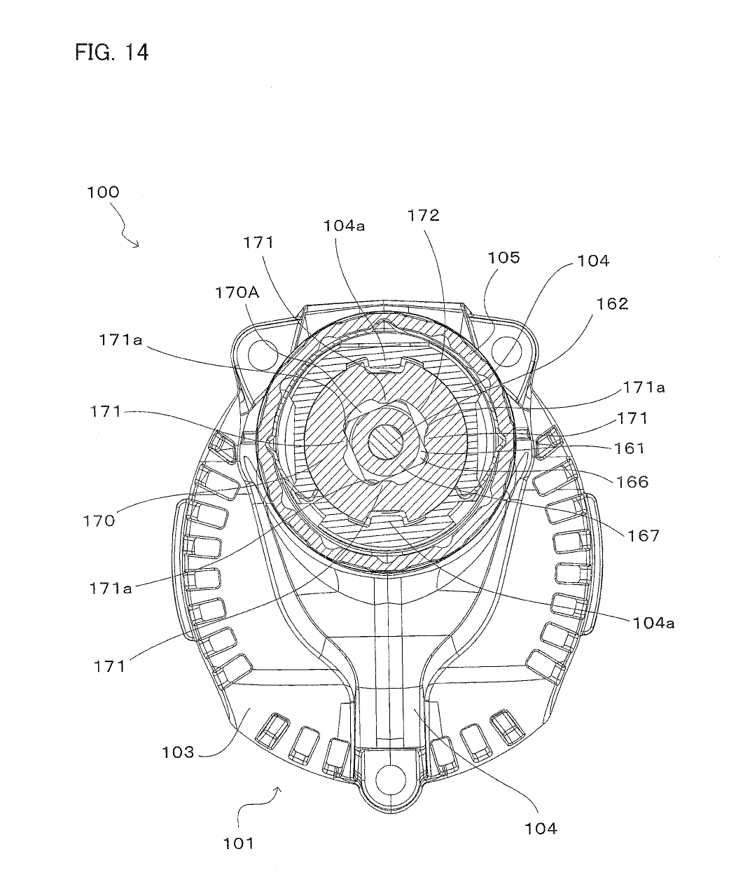

When the screw (not shown) on the tip of the tool bit 119 is further pressed against the workpiece, the spindle 160 is moved rearward from the first position to a prescribed position. This prescribed position of the spindle 160 is referred to as an intermediate position. The intermediate position is an example embodiment that corresponds to the “intermediate position” according to this invention. FIGS. 13 and 14 show a state in which the spindle 160 is located in the intermediate position. FIG. 14 is a sectional view taken along line in FIG. 13.

When the spindle 160 is moved from the first position (see FIG. 2) to the intermediate position shown in FIG. 13, the engagement ball 139 is also moved rearward. In the intermediate position of the spindle 160, like in the first position of the spindle 160, the inclined part 147a of the retainer engagement part 147 of the lock sleeve 145 does not come in contact with the inclined part 133a of the retainer 130. Therefore, like in the case when the spindle 160 is located in the first position, each roller 140a is held in the roller non-holding position in the roller engagement part 146a. Thus, when the spindle 160 is located in the intermediate position, rotation of the driving gear 125 is not transmitted to the spindle 160 via the rollers 140a.

As shown in FIGS. 13 and 14, in the intermediate position of the spindle 160, the non-engagement part 167 of the spindle 160 is located in the through hole 170A of the stopper 170. Thus, rotation of the spindle 160 is no longer prevented by the stopper 170.

Further, as shown in FIG. 13, the contact part 131A of the retainer 130 comes in contact with the spacer 124. At this time, rotation of the driving gear 125 is transmitted to the spindle 160 via the engagement pin 138 and by frictional force between the spacer 124 held in contact with the outer ring of the bearing 123 and the contact part 131A of the retainer 130 brought in contact with the spacer 124.

Therefore, when the spindle 160 is located in the intermediate position, the spindle 160 is rotated by the frictional force between the spacer 124 and the contact part 131A.

The frictional force between the spacer 124 and the contact part 131A can be arbitrarily set according to the structures of the spacer 124 and the contact part 131A.

For example, the frictional force may be set to such a value that torque with which a screw tightening operation can be performed on a workpiece having a hardness lower than a prescribed hardness and cannot be performed on a workpiece having the prescribed hardness acts on the spindle 160.

The user may use the screwdriver 100 to fix a gypsum board to a wooden backing with screws. A gypsum board has a lower hardness than a wooden backing. Therefore, even if the user tries to press a screw set on the tool bit 119 into a gypsum board, the pressing force may be absorbed by the gypsum board, so that a reaction force for moving the tool bit 119 to the second position which is described below may not be obtained. In such a case, it can be designed such that the frictional force between the spacer 124 and the contact part 131A is set to “such a value that enough torque for performing a screw tightening operation on the gypsum board acts on the spindle 160”.

When the frictional force between the spacer 124 and the contact part 131A is set to such a value and the spindle 160 is located in the intermediate position, the user can perform a screw tightening operation on the gypsum board. Further, when the screw reaches the wooden backing, the spindle 160 can obtain larger torque by moving to the second position. Thus, the screwdriver 100 can perform a screw tightening operation on the wooden backing, so that the gypsum board can be fixed to the wooden backing.

### (When the Spindle is Located in a Second Position)

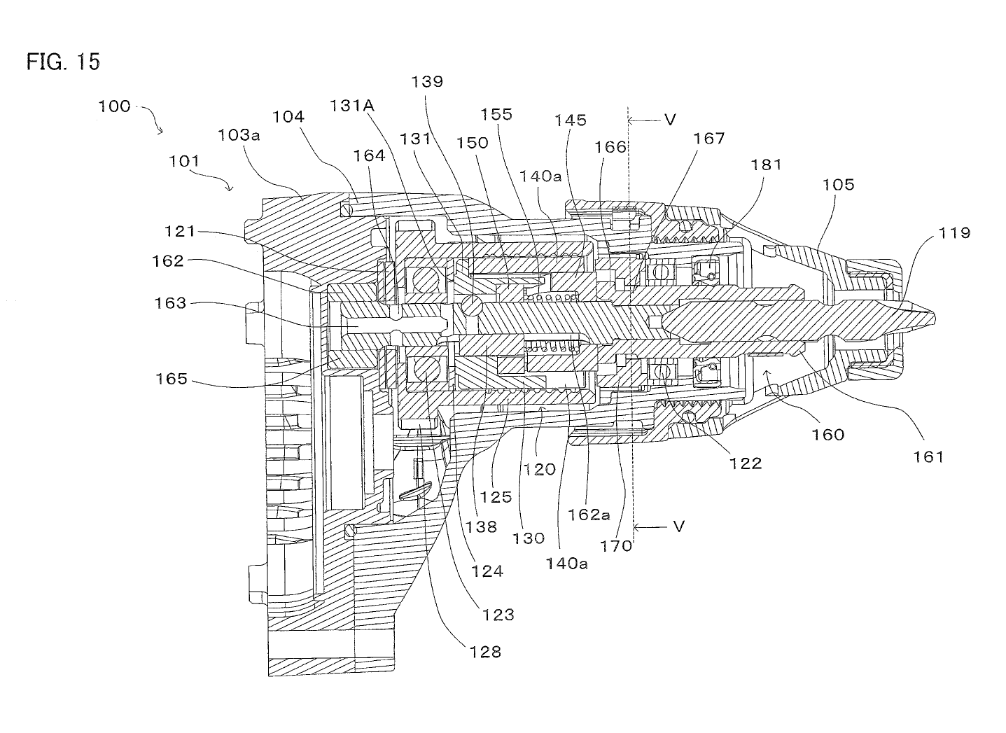

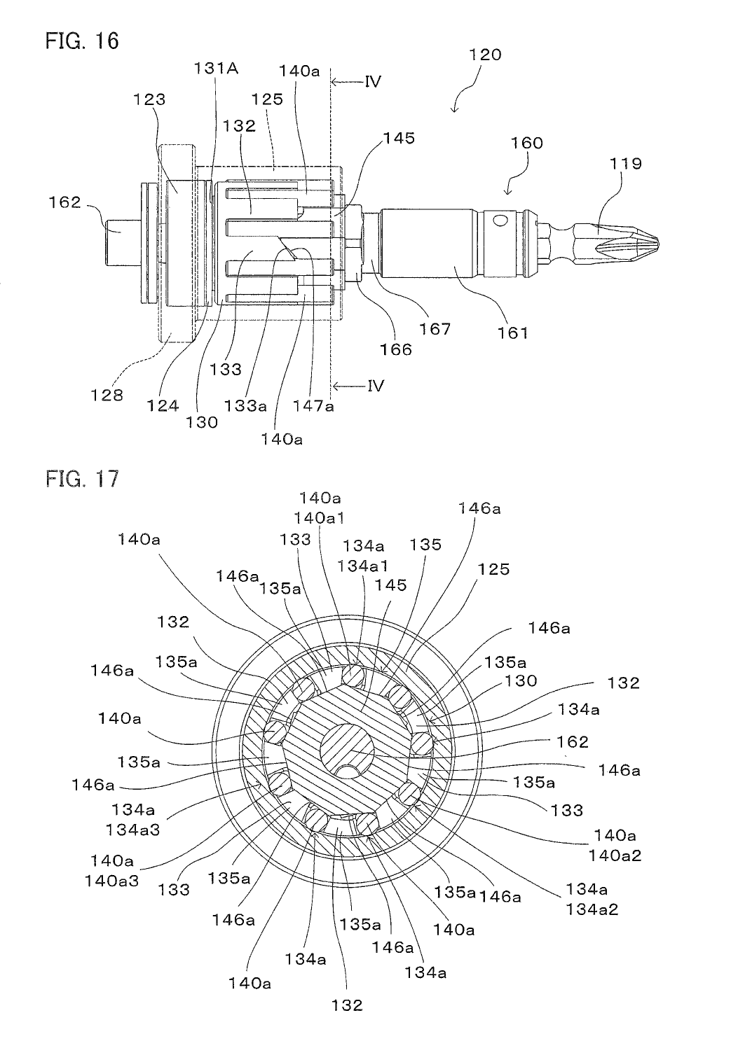

FIGS. 15 to 18 show a state in which the screw (not shown) on the tip of the tool bit 119 has been further pressed against the workpiece and the spindle 160 has been moved rearward from the intermediate position in the longitudinal direction of the screwdriver 100. This position of the spindle 160 is the rearmost position of the spindle 160 and is referred to as a second position. This second position is an example embodiment that corresponds to the “second position” according to this invention. FIG. 17 is a sectional view taken along line VI-VI in FIG. 16, and FIG. 18 is a sectional view taken along line V-V in FIG. 15.

As shown in FIG. 15, when the spindle 160 is moved from the intermediate position to the second position, the engagement ball 139 is also moved rearward. As shown in FIGS. 15 and 16, in the second position, the inclined parts 147a of the lock sleeve 145 come in contact with the inclined parts 133a of the retainer 130.

As shown in FIG. 17, by contact between the inclined parts 133a and the inclined parts 147a, the lock sleeve 145 is rotated in the circumferential direction with respect to the retainer 130 and the rollers 140a are held between the side wall 127 of the driving gear 125 and the roller engagement parts 146a of the lock sleeve 145. At this time, the rollers 140a act as a wedge, so that the driving gear 125 and the lock sleeve 145 are integrated via the rollers 140. Further, as shown in FIG. 15, the spring receiver 150 and the spindle 160 are integrated with the driving gear 125 and the lock sleeve 145 via the retainer 130 retaining the rollers 140a. As shown in FIG. 18, the spindle 160 is also rotated in the circumferential direction by rotation of the lock sleeve 145 in the circumferential direction.

As a result, rotation of the driving gear 125 is transmitted to the spindle 160 and the tool bit 119 is rotationally driven, so that the screwdriver 100 can perform a screw tightening operation on the workpiece.

The position (shown in FIG. 17) where the rollers 140a are held between the driving gear 125 (the side wall 127) and the lock sleeve 145 (the roller engagement parts 146a) and exhibits a wedge effect is referred to as a roller holding position or rotation transmitting position in the roller engagement parts 146a. In this case, the rollers 140a are placed in the roller holding position (rotation transmitting position) by rearward movement of the spindle 160 and relative circumferential movement of the lock sleeve 145 with respect to the retainer 130. This rotation transmitting position is an example embodiment that corresponds to the “holding position” according to this invention.

In the process in which the nine rollers 140a move from the rotation non-transmitting position (see FIG. 9) to the rotation transmitting position, all of the nine rollers 140a may be simultaneously held between the driving gear 125 and the lock sleeve 145, or one of the rollers 140a may be first held before the others are held between the driving gear 125 and the lock sleeve 145.

Here, the latter case in which one of the nine rollers 140a is first placed in the rotation transmitting position is now described with reference to FIG. 17. The “one roller 140a which is first placed in the rotation transmitting position” is defined as a first roller 140a1. The circumference around the rotation axis of the spindle 160 on which the transmitting element 140 is arranged defines one semi-circle and the other semi-circle by a diameter passing through the first roller 140a1. Four rollers 140a are arranged on each of the semi-circles. As shown in FIG. 17, one of the four rollers 140a on the one semi-circle is defined as a second roller 140a2, and one of the four rollers 140a on the other semi-circle is defined as a third roller 140a3. Further, the roller retaining part 134a retaining the first roller 140a1 is defined as a first roller retaining part 134a1, the roller retaining part 134a retaining the second roller 140a2 is defined as a second roller retaining part 134a2, and the roller retaining part 134a retaining the third roller 140a3 is defined as a third roller retaining part 134a3. The first roller 140a1, the second roller 140a2 and the third roller 140a3 are example embodiments that correspond to the “first transmitting member”, the “second transmitting member” and the “third transmitting member”, respectively, according to the present invention. The first roller retaining part 134a1, the second roller retaining part 134a2 and the third roller retaining part 134a3 are example embodiments that correspond to the “first transmitting member retaining part”, the “second transmitting member retaining part” and the “third transmitting member retaining part”, respectively, according to the present invention.

A reaction force which is caused when the first roller 140a1 is placed in the rotation transmitting position is propagated to a position point-symmetric to the first roller 140a1 with respect to the rotation axis of the spindle 160. In this position, however, the roller non-retaining part 135a is located. Therefore, the reaction force caused when the first roller 140a1 is placed in the rotation transmitting position is dispersed and propagated to the second and third rollers 140a2, 140a3. As a result, when the first roller 140a1 is placed in the rotation transmitting position, the second and third rollers 140a2, 140a3 are placed in the rotation transmitting position.

It is sufficient for the transmitting element 140 to connect the driving gear 125 and the lock sleeve 145 with such a strength as to allow smooth rotation of the spindle 160 when located in the rotation transmitting position. Therefore, all of the nine rollers 140a need not be placed in the rotation transmitting position. In order to stably connect the driving gear 125 and the lock sleeve 145, it is preferable that at least three of the rollers 140a are placed in the rotation transmitting position. According to this embodiment, by the above-described operation, the first, second and third rollers 140a1, 140a2, 140a3 can be stably placed in the rotation transmitting position.

The above-described positions of the second and third rollers 140a2, 140a3 are for convenience of explanation. The roller 140a on the one semi-circle which is placed in the rotation transmitting position by the effect of the reaction force caused when the first roller 140a1 is placed in the rotation transmitting position forms the second roller 140a2, and the roller 140a on the other semi-circle forms the third roller 140a3. The above explanation does not mean that only the three rollers 140a1, 140a2, 140a3 of the nine rollers 140a are placed in the rotation transmitting position, but that the other rollers 140a are also placed in the rotation transmitting position by the effect of the reaction force caused when the three rollers 140a1, 140a2, 140a3 are placed in the rotation transmitting position. At this time, all of the rollers 140a need not be placed in the rotation transmitting position.

Preferably, lines connecting extending axes of the three rollers 140a placed in the rotation transmitting position form an equilateral triangle. In the transmitting element 140 consisting of the nine rollers 140a, three combinations of three rollers 140a for forming the equilateral triangle can be made. Therefore, even if some of the rollers 140a are not placed in the rotation transmitting position due to accumulated tolerance, the positional relationship for forming the equilateral triangle can be formed by the three rollers 140a placed in the rotation transmitting position.

In a screw tightening operation, when a screw is screwed into a workpiece, the whole screwdriver 100 moves forward along with the movement of the screw, and the front surface of the locator 105 comes in contact with the workpiece. Thereafter, when the screw is further screwed into the workpiece, the spindle 160 holding the tool bit 119 moves forward with respect to the locator 105 (the front housing 104) in the screwdriver 100. Specifically, the spindle 160 is allowed to move from the second position shown in FIG. 15 to the first position shown in FIG. 2. In other words, the spindle 160 is pressed until the locator 105 comes in contact with the workpiece, so that the spindle 160 and the locator 105 are prevented from moving with respect to each other in the rotation axis direction of the spindle 160.

The biasing force of the coil spring 155 acts forward upon the spindle 160 via the lock sleeve 145. Further, the lock sleeve 145 presses the retainer 130 and moves (rotates) the retainer 130 around the rotation axis of the spindle 160, so that the lock sleeve 145 receives a reaction force from the retainer 130. Specifically, the inclined parts 147a of the lock sleeve 145 and the inclined parts 133a of the retainer 130 which are inclined with respect to the rotation axis of the spindle 160 are in contact with each other, so that the lock sleeve 145 receives a reaction force in the rotation axis direction of the spindle 160 and a reaction force around the rotation axis.

Therefore, during screw tightening operation, when the spindle 160 is allowed to move from the second position to the first position after the locator 105 comes in contact with the workpiece, the lock sleeve 145 is moved forward from the second position shown in FIG. 15 by the resultant (force in the rotation axis direction of the spindle 160) of the biasing force of the coil spring 155 and the reaction force from the retainer 130. Specifically, this resultant force exceeds the friction force between the rollers 140 and the lock sleeve 145. In other words, solely the biasing force of the coil spring 155 does not exceed the frictional force between the rollers 140 and the lock sleeve 145, but the resultant of the biasing force of the coil spring 155 and the reaction force from the retainer 130 exceeds the frictional force between the rollers 140 and the lock sleeve 145. Therefore, the lock sleeve 145 is not moved forward solely by the biasing force of the coil spring 155, but moved forward by the resultant of the biasing force of the coil spring 155 and the reaction force from the retainer 130. As a result, the lock sleeve 145 and the retainer 130 are separated from each other in the rotation axis direction of the spindle 160 and a gap is formed between the lock sleeve 145 and the retainer 130. Thus, the rollers 140 are released or disengaged from between the driving gear 125 and the lock sleeve 145. Specifically, the wedge action of the rollers 140 is released. Therefore, transmission of rotation from the driving gear 125 to the spindle 160 is interrupted so that the screw tightening operation is completed.

In the above-described embodiment, the screwdriver is explained as a representative example of the power tool, but it is not limited to this. The present invention may also be applied to a tool such as an electric drill in which a tool accessory is rotationally driven.

In view of the nature of the present invention, a power tool according to this invention may have the following features. Each feature may be used alone or in combination with others, or in combination with the claimed invention.

### (Aspect 1)

When the tool accessory holding part is switched to the second position by user's operation, at least three of the transmitting members are placed in the holding position.

### (Aspect 2)

The transmitting element includes three or more odd number of the transmitting members including the first, second and the third transmitting members.

### (Aspect 3)

Regions located in point symmetry to the transmitting members with respect to the rotation axis of the driving member form a transmitting member non-arrangement region.

### (Aspect 4)

The retainer has a bottom having an insertion hole through which the tool accessory holding part is inserted, and a first wall and a second wall which extend in the rotation axis direction of the driving member, and a space region between the first and second walls form a transmitting member retaining part.

### (Aspect 5)

Further, a space region is formed by cutting out the second wall of the retainer and forms a transmitting member retaining part.

### (Aspect 6)

A region of the first side wall or second side wall of the retainer which is located in point symmetry to the transmitting member retaining part with respect to the rotation axis of the driving member forms a transmitting member non-retaining part.

### (Aspect 7)

A power tool, which performs a prescribed operation by rotationally driving a tool accessory detachably held in a front end region of a tool body, comprising:

a motor,

a tool accessory holding part that is configured to be rotatable and to hold the tool accessory, and

a rotation preventing part that is capable of preventing rotation of the tool accessory holding part by engaging with the tool accessory holding part, and

a rotary drive mechanism that transmits rotation of the motor to the tool accessory holding part, wherein:

the tool accessory holding part is configured to be switched among a first position close to the front end region, a second position apart from the front end region and an intermediate position between the first position and the second position in a rotation axis direction of the tool accessory holding part,

the rotary drive mechanism includes:

a driving member that is rotationally driven by the motor,

a driven member that is arranged coaxially with the driving member and connected to the tool accessory holding part,

a transmitting element that is disposed between the driving member and the driven member and can be moved between a holding position to be held between the driving member and the driven member and a holding disabled position not to be held between the driving member and the driven member around a rotation axis of the driving member, and

a retainer that is arranged coaxially with the driving member and connected to the tool accessory holding part,

the retainer has a cylindrical shape and has a transmitting member retaining element for retaining the transmitting element and a first engagement part,

the driven member has a second engagement part that can engage with the first engagement part,

when the first engagement part and the second engagement part are disengaged from each other, the transmitting members are placed in the holding disabled position, and when the first engagement part and the second engagement part are engaged with each other, the transmitting members are placed in the holding position,

when the tool accessory holding part is located in the first position, the tool accessory holding part and the rotation preventing part are engaged with each other, the driving member and the retainer are separated from each other, and the first engagement part and the second engagement part are disengaged from each other,

when the tool accessory holding part is located in the intermediate position, the tool accessory holding part and the rotation preventing part are disengaged from each other, the driving member and the retainer come in contact with each other so that the tool accessory holding part is rotationally driven, and the first engagement part and the second engagement part are disengaged from each other, and

when the tool accessory holding part is located in the second position, the tool accessory holding part and the rotation preventing part are disengaged from each other, the driving member and the retainer come in contact with each other, and the first engagement part and the second engagement part are engaged with each other, whereby the transmitting members are placed in the holding position so that rotation of the driving member is transmitted to the driven member.

### (Correspondences Between the Features of the Embodiment and the Features of the Invention)

Correspondences between the features of the embodiment and the features of the invention are as follows. The above-described embodiment is a representative example for embodying the present invention, and the present invention is not limited to the structures that have been described as the representative embodiment.

The screwdriver 100 is an example embodiment that corresponds to the “power tool” according to the present invention. The body 101, the tool bit 119 and the spindle 160 are example embodiments that correspond to the “tool body”, the “tool accessory” and the “tool accessory holding part”, respectively, according to the present invention. The motor 110 and the driving mechanism 120 are example embodiments that correspond to the “motor” and the “rotary drive mechanism”, respectively, according to the present invention. The driving gear 125, the retainer 130, the roller 140a and the lock sleeve 145 are example embodiments that correspond to the “driving member”, the “retainer”, the “transmitting member” and the “driven member”, respectively, according to the present invention. The bottom wall 126 and the side wall 127 are example embodiments that correspond to the “bottom wall” and the “side wall”, respectively, according to the present invention. The through hole 126a is an example embodiment that corresponds to the “opening” according to the present invention. The housing space 129 is an example embodiment that corresponds to the “housing space” according to the present invention. The spiral groove 127a is an example embodiment that corresponds to the “spiral groove” according to this invention. The roller retaining part 134a and the roller retaining element 134 are example embodiments that correspond to the “transmitting member retaining part” and the “transmitting member retaining element”, respectively, according to the present invention. The roller non-retaining part 135a is an example embodiment that corresponds to the “transmitting member non-retaining part” according to the present invention. The transmitting element 140 is an example embodiment that corresponds to the “transmitting element” according to the present invention. The inclined part 133a is an example embodiment that corresponds to the “first engagement part” according to the present invention. The inclined part 147a is an example embodiment that corresponds to the “second engagement part” according to the present invention. The first position is an example embodiment that corresponds to the “first position” according to this invention. The rotation transmitting disabled position is an example embodiment that corresponds to the “holding disabled position” according to this invention. The intermediate position is an example embodiment that corresponds to the “intermediate position” according to this invention. The second position is an example embodiment that corresponds to the “second position” according to this invention. The rotation transmitting position is an example embodiment that corresponds to the “holding position” according to this invention. The first roller 140a1, the second roller 140a2 and the third roller 140a3 are example embodiments that correspond to the “first transmitting member”, the “second transmitting member” and the “third transmitting member”, respectively, according to the present invention. The first roller retaining part 134a1, the second roller retaining part 134a2 and the third roller retaining part 134a3 are example embodiments that correspond to the “first transmitting member retaining part”, the “second transmitting member retaining part” and the “third transmitting member retaining part”, respectively, according to the present invention.

### DESCRIPTION OF NUMERALS

100 screwdriver
101 body
103 main housing
103a partition wall
104 front housing
104a projection
105 locator
107 handle
107a trigger
107b changeover switch
109 power cable
110 motor
111 output shaft
111a bearing
111b bearing
112 gear teeth
119 tool bit
120 driving mechanism (rotary drive mechanism)
121 needle bearing
122 front bearing
123 bearing
124 spacer
125 driving gear
126 bottom wall
127 side wall
127a spiral groove
128 gear teeth
129 housing space
130 retainer
131 base
131A contact part
131a first engagement hole
131b second engagement hole
132 first side wall
133 second side wall
133a inclined part
134 roller retaining element (transmitting member retaining element)
134a roller retaining part (transmitting member retaining part)
134a1 first roller retaining part (first transmitting member retaining part)
134a2 second roller retaining part (second transmitting member retaining part)
134a3 third roller retaining part (third transmitting member retaining part)
135 roller non-retaining element
135a roller non-retaining part (transmitting member non-retaining part)
138 engagement pin
139 engagement ball
140 transmitting element
140a roller (transmitting member)
140a1 first roller (first transmitting member)
140a2 second roller (second transmitting member)
140a3 third roller (third transmitting member)
145 lock sleeve (driven member)
146 roller engagement element
146a roller engagement part
147 retainer engagement part
147a inclined part
150 spring receiver
155 coil spring
160 spindle
161 front shaft part
162 rear shaft part
162a groove
162b ball engagement part
163 hollow part
164 communication hole
165 rear end bearing
166 engagement part
166a engagement surface
167 non-engagement part
170 stopper
170A through hole
171 protruding region
171a engagement surface
172 curved surface region
173 recess
181 oil seal

1. A power tool, which performs a prescribed operation by rotationally driving a tool accessory detachably held in a front end region of a tool body, comprising:
a motor,
a tool accessory holding part that is configured to be rotatable and to hold the tool accessory, and
a rotary drive mechanism that transmits rotation of the motor to the tool accessory holding part, wherein:
the tool accessory holding part is configured to be switched by a user between a first position close to the front end region and a second position apart from the front end region in a rotation axis direction of the tool accessory holding part,
the rotary drive mechanism includes:
a driving member that is rotationally driven by the motor,
a driven member that is arranged coaxially with the driving member and connected to the tool accessory holding part,
a transmitting element that is disposed between the driving member and the driven member and can be moved between a holding position to be held between the driving member and the driven member and a holding disabled position not to be held between the driving member and the driven member around a rotation axis of the driving member, and
a transmitting member retaining element for retaining the transmitting element,
the transmitting element includes a plurality of transmitting members that define at least a first transmitting member, a second transmitting member and a third transmitting member,
the transmitting member retaining element includes a plurality of transmitting member retaining parts that define at least a first transmitting member retaining part for retaining the first transmitting member, a second transmitting member retaining part for retaining the second transmitting member and a third transmitting member retaining part for retaining the third transmitting member,
the transmitting member retaining element is disposed on a prescribed circumference around the rotation axis of the driving member,
a transmitting member non-retaining part is formed at a position point-symmetric to the first transmitting member retaining part on the circumference,
the circumference defines one semi-circle and the other semi-circle by a diameter passing through the first transmitting member retaining part, and the second transmitting member retaining part is arranged on the one semi-circle and the third transmitting member retaining part is arranged on the other semi-circle,
when the tool accessory holding part is located in the first position, the transmitting members are placed in the holding disabled position, so that transmission of rotation of the driving member to the driven member is interrupted, and
when the tool accessory holding part is switched to the second position by user's operation, the transmitting members are placed in the holding position, so that rotation of the driving member is transmitted to the driven member.

2. The power tool as defined in claim 1, wherein the transmitting member retaining parts are arranged at equal intervals on the circumference.

3. The power tool as defined in claim 1, wherein the transmitting element includes totally nine transmitting members including the first, second and third transmitting members.

4. The power tool as defined in claim 1, wherein:
the rotary drive mechanism has a retainer that is arranged coaxially with the driving member and connected to the tool accessory holding part,
the retainer has a cylindrical shape and has the transmitting member retaining element and a first engagement part extending inward of the transmitting member retaining element,
the driven member has a second engagement part that can engage with a region of the first engagement part located inward of the transmitting member retaining element,
when the tool accessory holding part is located in the first position, the first engagement part and the second engagement part are disengaged from each other and the transmitting members are placed in the holding disabled position, and
when the tool accessory holding part is located in the second position, the first engagement part and the second engagement part are engaged with each other and thereby the transmitting members are placed in the holding position.

5. The power tool as defined in claim 4, further comprising:
a rotation preventing part that prevents rotation of the tool accessory holding part by engaging with the tool accessory holding part when the tool accessory holding part is located in the first position, wherein:
the tool accessory holding part is configured to be switched to an intermediate position between the first position and the second position in the rotation axis direction of the tool accessory holding part,
when the tool accessory holding part is located in the first position, the tool accessory holding part and the rotation preventing part are engaged with each other, the driving member and the retainer are separated from each other, and the first engagement part and the second engagement part are disengaged from each other,
when the tool accessory holding part is located in the intermediate position, the tool accessory holding part and the rotation preventing part are disengaged from each other, the driving member and the retainer come in contact with each other so that the tool accessory holding part is rotationally driven, and the first engagement part and the second engagement part are disengaged from each other, and
when the tool accessory holding part is located in the second position, the tool accessory holding part and the rotation preventing part are disengaged from each other, the driving member and the retainer come in contact with each other, and the first engagement part and the second engagement part are engaged with each other, so that the transmitting members are placed in the holding position and rotation of the driving member is transmitted to the driven member.

6. The power tool as defined in claim 5, wherein the rotation preventing part and the tool accessory holding part are engaged in surface contact with each other.

7. The power tool as defined in claim 1, wherein:
the driving member has a bottom wall, a side wall and a housing space surrounded by the bottom wall and the side wall,
the bottom wall has an opening through which the tool accessory holding part is inserted,
the housing space houses at least part of the rotary drive mechanism, and
the side wall has a spiral groove for holding grease which is supplied to the rotary drive mechanism.

8. The power tool as defined in claim 1, wherein:
when the tool accessory holding part is switched to the second position by user's operation, the first, second and third transmitting members are placed in the holding position.

9. The power tool as defined in claim 1, wherein:
the transmitting element includes three or more odd number of transmitting members including the first, second and third transmitting members.

10. The power tool as defined in claim 1, wherein:
regions located in point symmetry to the transmitting members with respect to the rotation axis of the driving member define a transmitting member non-arrangement region.
